(19) United States
(12) Patent Application Publication
(10) Pub. No.: US 2015/0224607 A1
(43) Pub. Date: Aug. 13, 2015

(54) SUPERALLOY SOLID FREEFORM FABRICATION AND REPAIR WITH PREFORMS OF METAL AND FLUX

(71) Applicant: Siemens Energy, Inc., Orlando, FL (US)

(72) Inventors: Gerald J. Bruck, Oviedo, FL (US); Ahmed Kamel, Orlando, FL (US); Dhafer Jouini, Orlando, FL (US)

(73) Assignee: Siemens Energy, Inc., Orlando, FL (US)

(21) Appl. No.: 14/175,525

(22) Filed: Feb. 7, 2014

(51) Int. Cl. B23P 6/00; B23K 26/00; B22F 3/105; B23K 25/00; B23K 35/02; B23K 35/36

(52) U.S. Cl. CPC B23P 6/002; B23K 35/0255; B23K 35/36; B22F 3/105; B23K 25/005; B23K 26/0012; B33Y 10/00

(57) ABSTRACT

A preform (22, 22A-U) containing metal (32, 34) and flux (33) for forming a metal layer to be added to a component being repaired or additively manufactured. The metal may be constrained in the preform in a distribution that forms a shape of a sectional layer or a surface repair of a component in response to an energy beam (58) that melts the preform. The preform is placed on a working surface (42), which may be a previously formed layer (42A-C) in additive manufacturing, or may be an existing component surface (122) for repair The preform is then melted by the energy beam (58) to form a new integrated layer (40A-F) on the component with an over-layer of slag (56) that shields and insulates the melt pool (54) and the solidifying layer The slag is removed, and a subsequent layer may be added.

### FIELD OF THE INVENTION

This invention relates generally to the field of solid freeform fabrication and repair of metal components, and particularly to additive layer fabrication and repair of high-temperature superalloy components

### BACKGROUND OF THE INVENTION

Industry is increasingly using Solid Freefrom Fabrication (SFF) technologies to produce fully functional metal parts. This family of additive manufacturing processes involves layer-wise accumulation and consolidation of material (e.g. powder and wire), allowing parts to be produced with a high geometric freedom directly from a CAD model. A group of SFF technologies known as direct metal laser fabrication (DMLF) utilizes lasers to consolidate powder. Other groups use tungsten inert gas (TIG), Metal inert gas (MIG), or electron beam technologies.

Additive manufacturing enables a component to be fabricated by building it in layers. Each layer is melted, sintered, or otherwise integrated onto a previous layer. Each layer may be modeled as a slice of a numeric solid model of the component Superalloy materials are among the most difficult materials to fabricate and repair due to their susceptibility to melt solidification cracking and strain age cracking The term “superalloy” is used herein as it is commonly used in the art—a highly corrosion and oxidation resistant alloy with excellent mechanical strength and resistance to creep at high temperatures Superalloys typically include high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

Weld repair of superalloy components has been accomplished by preheating the substrate to a high temperature (for example to above 1600° F. or 870° C.) in order to increase the ductility of the material during the repair. This technique is referred to as hot box welding or superalloy welding at elevated temperature (SWET). It is commonly performed using manual gas tungsten arc welding (GTAW). However, hot box welding is limited by the difficulty of maintaining a uniform component process surface temperature and the difficulty of maintaining complete inert gas shielding, and by physical difficulties imposed on the operator working in the proximity of a component at high temperatures.

Some superalloy welding applications can be improved by using a chill plate to limit the heating of the substrate material, thereby limiting the occurrence of substrate heat affects and stresses causing cracking problems. However, this technique is not practical for many repair applications where the geometry of the parts does not facilitate the use of a chill plate.

FIG. 1 illustrates the relative weldability of various alloys as a function of their aluminum and titanium content. Alloys such as Inconel® IN718 which have relatively lower concentrations of these elements, and consequentially relatively lower gamma prime content, are considered relatively weldable, although such welding is generally limited to low-stress regions of a component. Alloys such as Inconel® IN939 which have relatively higher concentrations of these elements have traditionally not been considered to be weldable, or to be weldable only with the special procedures discussed above which increase the temperature/ductility of the material and which minimize the heat input of the process. A dashed line 18 indicates a recognized upper boundary of a zone of weldability. The line 18 intersects 3 wt % aluminum on the vertical axis and 6 wt % titanium on the horizontal axis. Alloys outside the zone of weldability are recognized as being very difficult or impossible to weld with traditional processes, and the alloys with the highest aluminum content are generally found to be the most difficult to weld, as indicated by the arrow.

The DMLF process of selective laser melting (SLM) has been used to melt a thin layer of superalloy powder particles onto a superalloy substrate for repairs, and to melt thin beds of such particles in successive layers for solid freeform fabrication The melt pool is shielded from the atmosphere by an inert gas such as argon during the laser heating These processes tend to trap oxides (eg aluminum and chromium oxides) on the surface of the particles within the layer of deposited material, resulting in porosity, inclusions and other defects associated with the trapped oxides Post-process hot isostatic pressing (HIP) is often used to collapse these voids, inclusions and cracks in order to improve the properties of the deposited coating.

Selective laser melting (SLM) is the fusing of metallic particles in a powder bed by the application of localized laser heat to melt the powder and form a melt pool which solidifies as a consolidated layer of material that forms a solid cross section. When interaction of laser radiation with metal powder occurs, the energy deposition is highly dependent on powder-coupling mechanism. Multiple reflections between the powder particles leads to higher optical penetration depths compared to solid material. However, versions of SLM have had some or all of the following disadvantages:
a) Limited to processing on a flat horizontal surface in a chamber in order to retain the powder by gravity during laser processing
b) Limited to weldable materials such as shown in FIG. 1.
c) A slow process, because each layer must be thin, such as 20 microns. Using thicker layers might require a higher energy density which could cause cracking.
d) Requires an inert shielding gas to avoid oxidation.
e) Requires preheating of the substrate and/or the powder to avoid cracking.
f) Limited in the usable energy density An increase in energy density causes a larger degree of melting causing the material to form spherical balls rather than build a consistent layer.
g) Requires post-processing operations such shot peening and hot isostatic pressing (HIP) to remove voids and contaminants.
h) Process is highly sensitive to powder production method.

Laser cladding is an alternate SFF process commonly used It is typically used in depositing a metallic filler material onto the surface of a substrate to form a metal layer for repair or additive manufacture. The laser melts the surface of the substrate to form a melt pool into which the metallic filler material is continuously injected thus forming a metal layer or “clad” on the surface. An alternate form of laser cladding uses pre-placed powder on the surface of the substrate. Various versions of laser cladding have had some or all of the following disadvantages:
a) Slow process because each layer must be thin, such as 0.5 mm.
b) Even slower for materials that are hard to weld as shown in FIG. 1
c) Requires an inert shielding gas to avoid oxidation
d) Requires high preheating or fast cooling of the substrate to avoid cracking
e) In some cases there is sensitivity to the powder production method

As new superalloys continue to be developed, the challenge to develop commercially feasible joining processes for superalloy materials continues to grow These joining processes have direct impact on the repair and SFF applications for superalloys. Both selective laser melting and laser cladding depend on the laser coupling efficiency, which depends on many factors, among which are powder size, powder quality and laser energy density. Powder sizes used in typical powder based processes are shown in FIG. 2 for plasma spray, high velocity oxygen fuel spray (HVOF), low pressure plasma spray (LPPS), cold gas spray, selective laser melting (SLM), combustion spray, plasma transferred arc spray, and laser cladding. The usable powder size distribution differs with process, and is distinct between SLM and laser cladding in particular. This constitutes a limitation on each of these processes for SFF of superalloys, both in terms of optimization of laser coupling and in customization of particle sizes for other reasons. Larger particles reduce process oxidation due to the lower surface area. Smaller particles provide finer definition of structural features in the component. Therefore, a larger range of particles sizes for superalloy SFF process optimization would be useful

### BRIEF DESCRIPTION OF THE DRAWINGS

The invention is explained in the following description in view of the drawings that show.

FIG. 1 illustrates relative weldability of various superalloys.

FIG. 2 illustrates ranges of particle sizes for existing additive processes.

FIG. 3 is a side sectional view of a preform showing aspects of an embodiment of the invention.

FIG. 4 is a transverse sectional view of a dual-wall gas turbine blade.

FIG. 5 is a top sectional view of a preform to create a layer of the blade of FIG. 4.

FIG. 6 illustrates a process of solid freeform manufacturing according to aspects of the invention.

FIG. 7 is a perspective sectional view of a preform made of tubes containing different materials for different additive layers

FIG. 8 is a transverse sectional view of a mandrel wrapped with conforming preforms

FIG. 9 is a top view of a split plate with a cavity holding a preform for a turbine airfoil.

FIG. 10 is a side sectional view of a preform with interior blocks of laser blocking material that provide grooves in a layer or outer surface of a component

FIG. 11 is a side sectional view of a substrate and grooved surface of a component resulting from the preform of FIG. 10.

FIG. 12 is a sectional perspective view of a preform with interior blocks of laser blocking material having cavities for additional additive material.

FIG. 13 is a side sectional view of a substrate and surface of a component resulting from the preform of FIG. 12

FIG. 14 is a top sectional view of a preform embodiment with internal blocks of pre-sintered porous metal for surface tension removal.

FIG. 15 illustrates a process of forming a metal/flux preform by spark plasma sintering

FIG. 16 illustrates a process of repairing a component using a metal/flux preform

FIG. 17 is a sectional view of a component with a degraded surface.

FIG. 18 shows a set or stack of preforms for forming a portion of a gas turbine airfoil.

FIG. 19 shows a tip portion of a gas turbine blade with a squealer tip rebuilt using preforms according to an aspect of the invention.

### DETAILED DESCRIPTION OF THE INVENTION

The present inventors developed a process and apparatus for solid freeform fabrication and repair having the following advantages:
a) Can build on existing 3-D surfaces Not limited to horizontal flat surfaces
b) High build rate, such as over 3 or 4 mm per layer
c) Usable for metals that are difficult to weld
d) Robust process that is adaptable to new damage modes.
e) No pre-heating or fast cooling needed.
f) No shielding of the melt pool by inert gas is needed
g) Wide range of powder sizes.
h) Reduced sensitivity to the powder production method.

An embodiment of the invention includes the steps described here. A preform of metal powder and flux powder is created that contains metal to be added to a component being additively fabricated or repaired The metal in the preform may be constrained in a distribution that defines a shape of a layer or slice of the component. The preform is preplaced on a working surface such as a work table, a component surface for repair, or a previous layer in additive fabrication. The preform is then melted by a directed energy, such as a laser beam or other form of energy This forms a layer of metal and an over-layer of slag that shields and insulates the layer during processing The slag is then removed, and a subsequent layer may be added.

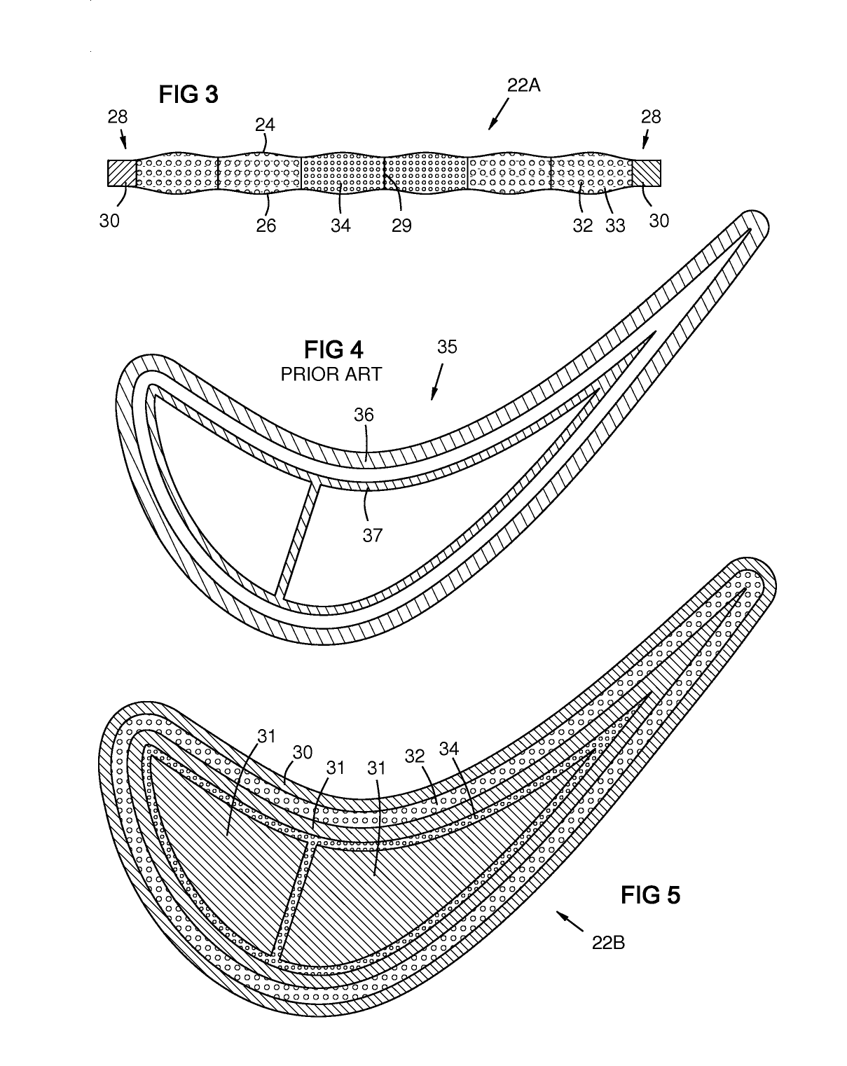

FIG. 3 shows a sectional side view of a preform 22A embodied as a closed container such as a bag, envelope, sleeve, or tube containing unbound particles of metal 32, 34 and flux 33. “Unbound” means loose, as opposed to consolidated, compacted, and/or sintered together into a block or other self-supporting form A benefit of unbound particles is that laser energy penetrates to a greater depth by reflection between the particles than with a solid preform such as is described later herein. The particles may constitute respective metal and flux particles mixed in a predetermined volume ratio, or the particles may constitute metal particles coated with or containing flux, such as are described in United States patent application publication US 2013/0136868 dated 30 May 2013, incorporated by reference herein. The container has walls 24, 26 with a sealed periphery 28. The walls may be sheets of any type, such as fabric, film, or foil that retains the powder. The sheets may be made of a material that does not create detrimental smoke and ash, and may contribute to the flux, such as aluminum foil, or a fabric of alumina or silica fibers. The container may be quilted or subdivided by partitions 29 to retain a particle distribution that creates a desired shape of the metal layer in response to the energy beam. Such partitions 29 may also be useful for non-horizontal material deposition applications Some variation in thickness of the preform is tolerable, since the melt pool is self-leveling to some extent The partitions may provide compartments of particles 32, 34 of different sizes and/or different materials optimized for varying requirements over the section of the component Larger particle sizes may be provided for larger structural features, and smaller particle sizes may be used for smaller, more detailed structural features A fabric-walled compartment may have a mesh size appropriate for retaining a respective particle size and may be varied accordingly across a preform, as appropriate, or it may be lined, such as with aluminum foil, to retain fine powdered particles. The aluminum then becomes a constituent of the alloy melt.

Optionally, the periphery 28 may include a non-metallic, non-melting, laser blocking material 30, such as graphite or zirconia, which provides an energy absorbing turn-around area for the laser scan lines outside the melt pool This avoids excess heating of the periphery of the layer. The laser-blocking material 30 may form a solid peripheral frame to which the peripheries 28 of the walls 24, 26 may be attached with high-temperature cement Such a frame provides a highly defined outer surface of the fabricated component. A laser-blocking material with high thermal conductivity such as graphite induces a fine grain structure in the solidified metal by promoting fast cooling A laser-blocking material with low thermal conductivity, such as zirconia, may be useful to induce directional solidification by limiting a direction of heat removal to be primarily in a direction of a preferred grain orientation. Thus, the grain structure of the metal can be customized and varied over the component by selection of the surrounding materials. Using this approach it is possible to maintain a well defined transition from equiaxed to columnar grain structures, thus providing layers that have both columnar and equiaxed features in specific areas Optionally, particles of dry ice may be mixed with the particles 32 of metal and flux or may be contained in a peripheral or interior compartment in place of, or in addition to, the laser blocking material 30 to control heating and to supply an oxidation shield of CO₂ gas.

FIG. 4 is a simplified transverse sectional view of a dual-wall gas turbine blade 35 to be formed by an embodiment of the present process and apparatus The outer wall 36 is thicker than the inner wall 37, representing areas with different particle size requirements

FIG. 5 is a top sectional view of a preform embodiment designed to create a sectional layer of the blade of FIG. 4. The preform contains a first shaped section of larger particles 32 to form the outer wall 36, and a second shaped section of smaller particles 34 to form the inner wall 37 It may further contain laser-blocking borders 30 such as graphite for laser turn-around areas. It may also contain interior laser-blocking sections 31 to provide high definition of the interior surfaces of the component and control the grain structure. A similar preform without the inner wall section 34 can facilitate the repair a squealer tip of a gas turbine blade A squealer tip is a peripheral ridge on the blade tip which becomes worn or cracked with use. The worn ridge may be milled and rebuilt with one or more layers on top of the milled ridge or the blade tip using a preform in accordance with an embodiment of the invention.

Graphite does not adhere to metal, so the laser-blocking sections 30, 31 can be easily removed after laser processing of each layer The laser blocking sections may be particulate or solid Optionally, the laser-blocking sections may be allowed to accumulate layer by layer until fabrication is complete, so that each laser-blocking section is supported on the previous laser-blocking sections Solid laser-blocking sections may have a registration feature such as protrusions on an upper surface and depressions on the lower surface thereof to register the current preform relative to the previous one

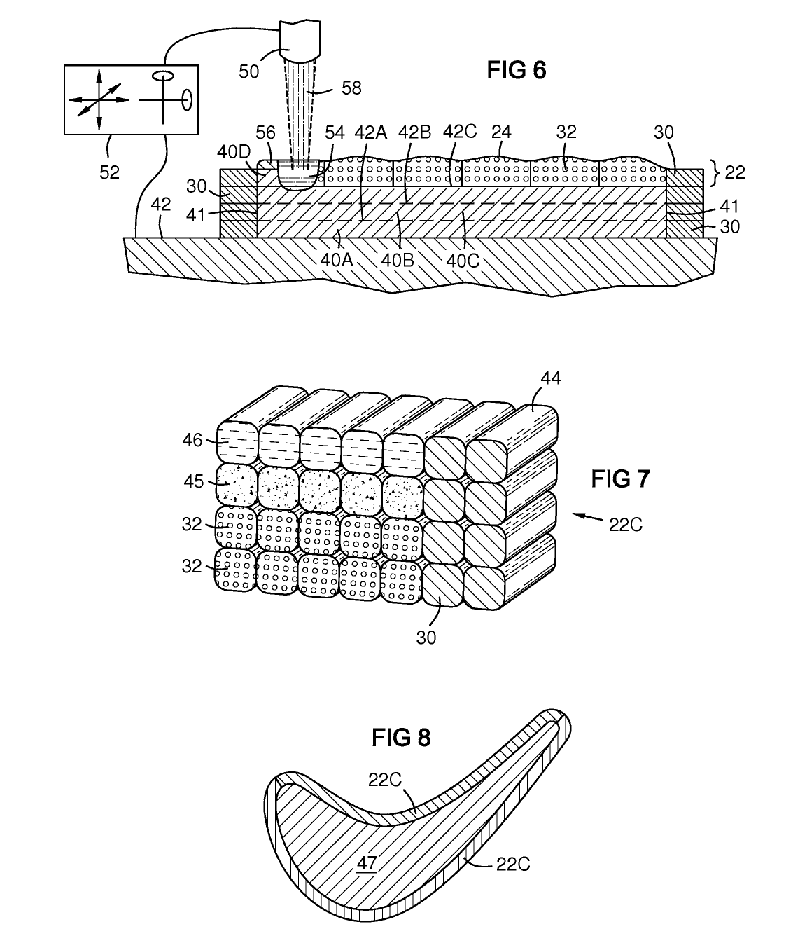

FIG. 6 illustrates a process of freeform additive fabrication in accordance with aspects of the invention A component such as a gas turbine blade is fabricated layer by layer 40A-D over a working surface 42 Each layer provides a new working surface 42A-C for the next layer, which is added by placing a preform 22 containing particles 32 of metal and flux on the last working surface 42C, and directing energy 58 onto the preform. The original working surface 42 and/or the energy emitter 50 may be moved on multiple axes 52 so that the energy beam 58 may be traversed or rastered or moved in any desired pattern across the preform in a progression of paths, such as generally parallel or zigzag paths that heat the metal sufficiently to integrate it with the previous layer. A melt pool 54 may form at a focus or impingement spot of the directed energy 58 on the preform. Optionally, graphite borders 30 of the preforms may be allowed to accumulate until fabrication is complete This supports the current border on the previous border, thus supporting border alignment to perfect the outer surfaces 41 of the component.

The process of FIG. 6 may further include making the particles 32 of multiple metal constituents that combine during the melting process to create a desired final superalloy material that constitutes the metal layer 40A-D at the time of fabrication. This allows customizing each metal layer 40A-D for desired properties by varying proportions of constituents. It may be used create a gradient of constituents and corresponding properties that vary with the depth of the layering 40A-D

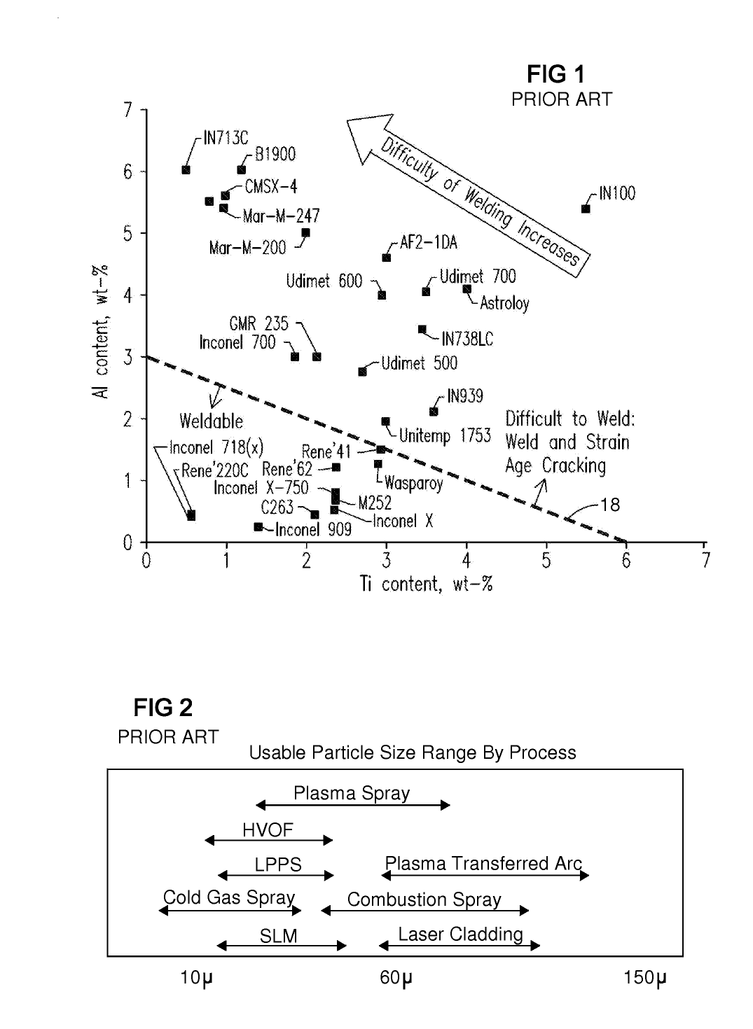

The flux and the resulting slag 56 may be constituted to absorb the directed energy and/or to be transparent or translucent to it. Examples of flux materials that may be used include commercially available fluxes such as those sold under the names Lincolnweld P2007, Bohler Soudokay NiCrW-412, ESAB OK 10.16 or 10 90, Special Metals NT100, Oerlikon OP76, Sandvik 50SW or SAS1. Any of the currently available iron, nickel or cobalt based superalloys used for high temperature applications such as gas turbine engines may be fabricated, joined, repaired, or coated with the inventive process, including the superalloys previously mentioned herein and labeled in FIG. 1

The flux may include constituents that control the slag properties regarding absorption and/or transmission of the directed energy 58. For example, materials may be included that provide optical transmission of laser energy through the slag as well as shielding and insulation for the melt pool Such materials may include some or all the following properties:
1. Molten at temperatures less than the melting point of the metal alloy (for example less than 1260° C.)
2. At least partially optically transmissive to the energy beam wavelength
3. Shields the molten metal from reaction with air.
4. Optionally may include constituents that are additive to the alloy melt
5. Optionally may include elements that reduce the temperature coefficient of surface tension or viscosity of the molten pool for improved self-leveling.

The flux material and the resultant layer of slag 56 provide functions that are beneficial for preventing cracking of the new layer 40D and the underlying substrate material or previous layer 40C. First, the slag functions to shield both the melt pool 54 and the recently solidified metal from the atmosphere in the region downstream of the directed energy 58, separating the molten and hot metal from the atmosphere. Second, the slag acts as a blanket that allows the solidified material to cool slowly and evenly, thereby reducing residual stresses that can contribute to post weld reheat or strain age cracking. Third, the flux material provides a cleansing effect for removing trace impurities such as sulfur and phosphorous that contribute to weld solidification cracking Such cleansing includes deoxidation of the metal powder. Finally, the flux material may provide an energy absorption and trapping function to more effectively convert the directed energy 58 into heat, thus facilitating precise control of heat input, such as within 2%, and a resultant tight control of material temperature during the process. Additionally, the flux may be formulated to compensate for loss of volatized elements during processing or to actively contribute elements to the deposit that are not otherwise provided by the metal powder itself. Together, these benefits allow crack-free additive layering on superalloy substrates at room temperature for materials that traditionally were believed only to be joinable with a hot box process or through the use of a chill plate. Additionally, the flux may be formulated to add elements that reduce the surface tension or viscosity of the melt pool thus avoiding the commonly known surface tension “balling” effect in SLM

FIG. 7 is a perspective sectional view of a preform embodiment 22C formed of one or more layers of tubes 44 containing one or more additive materials. The tubes may be made of fabric, for example using alumina or silica fibers. The tubes may be stitched, woven, or cemented together. Alternately, the tubes may be extruded and cemented together. Optionally, multiple layers of tubes may be combined in a single preform as shown to hold different additive materials for different layers For example, a first layer may contain particles 32 of a structural superalloy and flux, a second layer may contain particles 45 of a metal-to-ceramic bond coat material (such as an MCrAIY alloy) and flux, and a third layer may contain particles 46 of a ceramic thermal barrier material Such a multi-layer preform may be used to repair surface cracks in a component such as a gas turbine blade or platform and/or to restore an aged surface including a thermal barrier The tubes may be parallel as shown, or orthogonal in different layers, or they may follow contours of a component, such as the curved walls 36, 37 of the blade section of FIG. 4. In one embodiment, layers of a metal-to-ceramic bond coat 45 and a ceramic thermal barrier 46 are provided in a single preform to add a thermal barrier layer to an existing or newly fabricated substrate or to restore a thermal barrier after removal of the old one.

FIG. 8 is a transverse sectional view of a mandrel 47 wrapped with conforming preforms such as embodiment 22C to form an outer wall of a turbine blade. For example, the innermost preforms used for the turbine wall may contain all metal and flux particles 32, and the outer preform may contain materials for a bond coat layer and ceramic thermal barrier layer

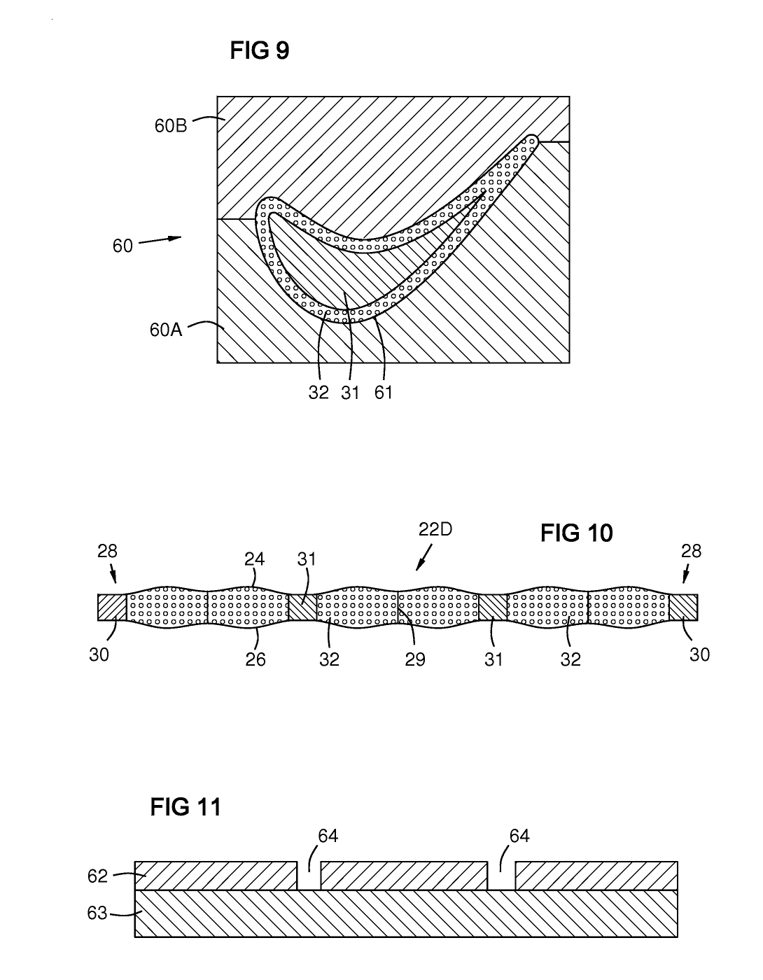

FIG. 9 is a top view of a split plate (mold) with two or more separable parts 60A, 60B surrounding a cavity 61 for holding a preform 31, 32 for a turbine airfoil This plate may be used to bound a preform to register it and accurately define its periphery. The plate may have the thickness of one or more preforms. Optionally, it may be thick enough to hold multiple preforms in succession as the component structure is built, thus highly defining the outer surface of the component The material of the plate may be selected to control the solidification rate and thus the solid internal structure of the work piece similarly to the energy blocking materials previously described Successive layers may be built with different split plates of different materials to vary the grain structure of the component along a height or span of the component by varying its cooling parameters. A higher thermal conductivity material will tend to transfer heat out of the melted metal more rapidly, thus promoting smaller grain size, while a lower thermal conductivity material will tend to transfer heat out of the melted metal more slowly, thus promoting larger grain size. The parts 60A, 60B of the split plate may be made of different materials to vary the grain structure around the component. For example, the pressure side of the resulting turbine blade may have a different grain structure than the suction side. Thus the grain structure can be customized and varied over the component by selection of the materials of the split plate. Using this approach it is possible to maintain a well defined transition from equiaxed to columnar, thus providing a grain structure that has both columnar and equiaxed areas. Interior laser blocking sections 31 may be provided in the preform as previously described Exemplary materials for the split plate and for the internal laser-blocking sections are graphite for high thermal conductivity or zirconia for low thermal conductivity

FIG. 10 is a side sectional view of a preform embodiment 22D with walls 24, 26 enclosing particles 32 of metal and flux The periphery 28 may include a peripheral frame of a laser blocking material 30 Interior blocks or fibers of energy blocking material 31 such as graphite may be provided for texturing of a surface layer as shown in FIG. 11. By using such a preform 22D, a layer 62 of a substrate 63 may be provided with grooves or depressions 64 of any size and depth for benefits such as retaining a subsequently applied thermal barrier layer.

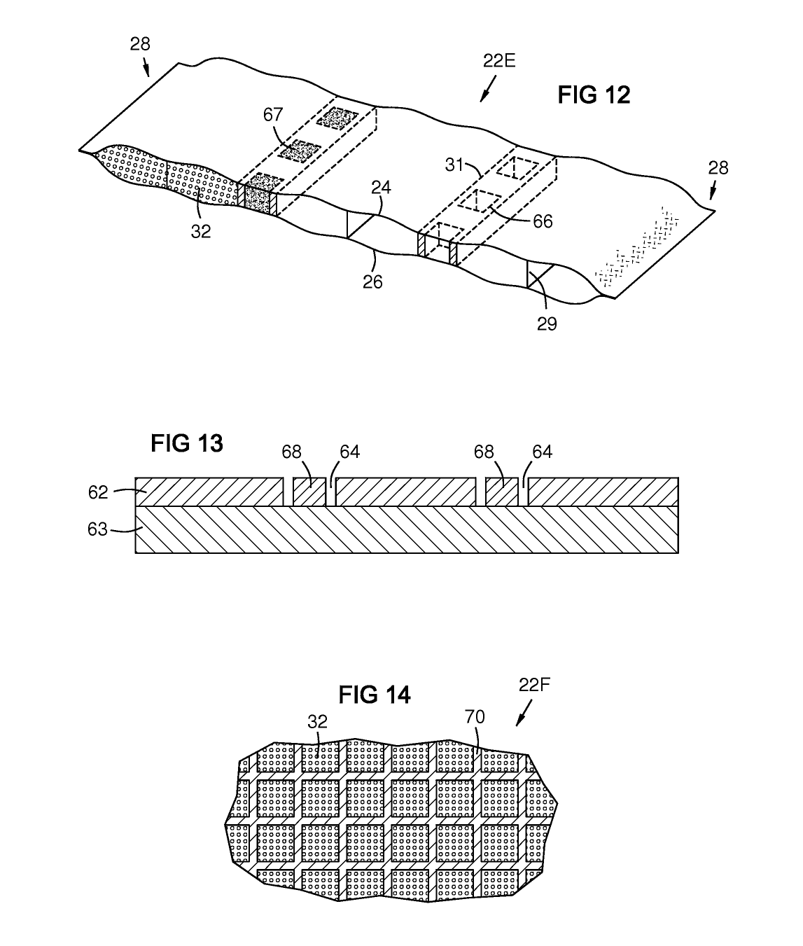

FIG. 12 is a sectional perspective view of a preform with interior blocks of laser blocking material 31 containing cavities 66 to contain additional additive material 67, which may be the same or a different type of material than a first additive material 32 of the preform. FIG. 13 is a side sectional view of a component structure resulting from such a preform 22E for a layer 62 of a substrate 63. The structure has both grooves 64 and columns 68. This is useful for example for retaining a thermal barrier layer on a surface of the component, where the columns 68 may provide a bond coat material.

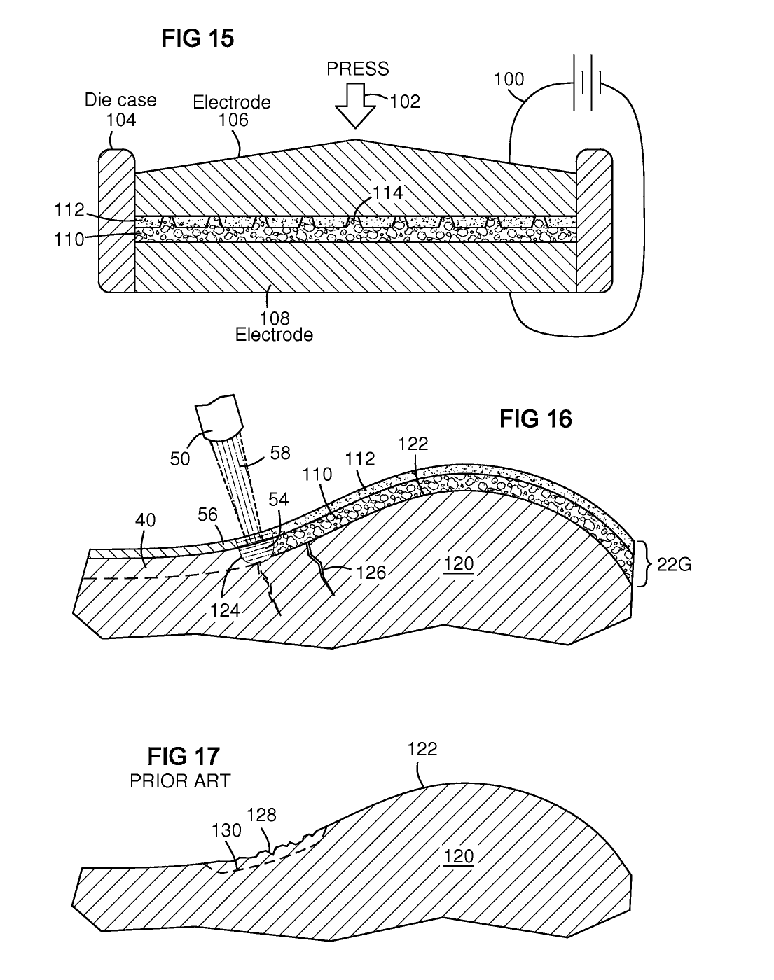

FIG. 14 is a top sectional view of a preform embodiment 22F with internal inclusion of pre-sintered metal such as runners or blocks 70 formed with a high percentage of open porosity, for example by spark plasma sintering. During laser melting of the particles 32, the pre-sintered blocks 70 attract the melt by adhesion and capillary action, thus preventing balling of the melt by surface tension The metal blocks 70 may be formed of the same or different alloy from the particles 32. The blocks may have at least 40% void fraction so they fill with the melt like a sponge during laser processing. The blocks 70 may be configured in a crossing pattern as shown, or in other patterns such as parallel lines or curves. The porous pre-sintered blocks reduce final thermal stresses in the component, especially in the shown crossing pattern

Optionally, the preform may include a thermochromatic transition metal oxide, examples of which include titanium dioxide, vanadium oxide or a mixture of chromium oxide and aluminum oxide. At least a portion of the metal component may include thermochromatic material after fabrication, such as having such material in a top layer of the component in order to display the temperature on the surface of the component during subsequent operation. Alternatively, the preform may include a piezo-electric material such as synthetic ceramics or lead-free piezo-ceramics At least a portion of the metal component, such as a surface portion, may include the piezo-electric material after fabrication, in order to indicate sectional or surface strain by voltages accessible on the surface, such as by insulated electrical conductors also formed into the component by selective design of preforms used to form the component The pre-sintered metal blocks may be produced using spark plasma sintering, powder injection molding or any process that allows controlling the porosity of the metal block.

FIG. 15 illustrates an alternate process of forming a preform by spark plasma sintering 100 (SPS) with compression 102 A die case 104 may be provided with a first electrode 106 and a second electrode 108, at least one of which may be movable, for compacting and sintering a metal alloy powder 110 and a flux powder 112. The two powders may be compressed and sintered at the same time, or in two different steps using different voltages. The two powders may be disposed in two distinct layers as shown, and/or they may be mixed uniformly or in a gradient composition. Precise control of the powder ratios and their relative positions and shapes is possible by preforming them in this way, in contrast to feeding them at the time of additive melting or disposing them in open powder beds. Texturing features 114 such as depressions or bumps may be formed on the outer surface of the metal powder portion 110 to provide benefits such as anchoring for a protective coating on the component The texturing may be formed in a first sintering step of the metal powder 110 using an electrically conductive shaping form on the bottom of the upper electrode 106 followed by removal of the form, then depositing and sintering the flux powder in a second step

Hollow ceramic spheres (not shown) may be mixed with the metal powder 110 to add a predetermined void fraction to the metal layer to lower its thermal conductivity Alternately, the metal powder portion of a preform may be formed with a porosity determined by a voltage, compression, and duration of the spark plasma sintering and a particle size distribution of the metal powder 110 The power and duration of the directed energy beam may be limited during additive processing to retain a portion of the porosity in the component.

FIG. 16 illustrates a process of repairing a component 120 with a non-planar or non-horizontal surface 122 using a preform 22G conforming to the surface 122. This illustrates a benefit of preforms over open powder beds, which can slide on non-horizontal surfaces and the melt pool can run downhill. The preform 22G retains the melt pool 54 on all sides 124, allowing repair of surfaces that are over 10 or 20 degrees from horizontal. The directed energy 58 can be focused and controlled to create a melt pool of predetermined size and viscosity such that surface tension of the melt pool retains it within surrounding solid sides 124 over a range of non-horizontal angles Some flux material may be provided on the bottom of the preform 22G and/or mixed with the metal material 110 so that the molten metal fills cracks 126, thus sealing and eliminating them The preform may add an outer layer 40 to the component and a slag layer 56 to be removed.

FIG. 17 shows a portion of a component 120 with a surface 122 that is degraded by a damaged portion 128 The damaged portion may be removed by milling or other means, forming a depression 130 in the surface. A preform may be shaped to fill the depression Alternately, a preform may be formed in a desired repair shape, and the depression 130 may be milled to match the shape of the preform.

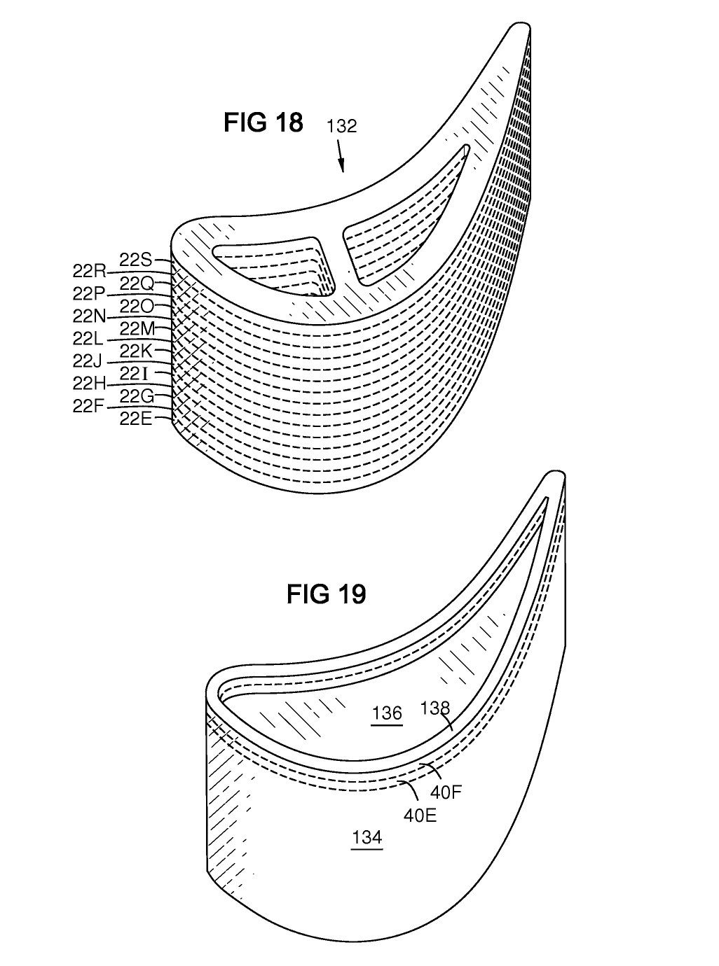

FIG. 18 shows a set 132 or stack of preforms 22E-S for forming a portion of a gas turbine airfoil Preforms in accordance with aspects of the invention may be provided in a set or sets for forming part or all of a component. Using this approach a higher degree of homogeneity with respect to element distribution and grain size can be maintained Preforms with internal porous metal blocks as previously described can be used in alternating layers to reduce thermal stress and hence the final part distortion.

FIG. 19 shows a tip 136 of a gas turbine blade 134 with a radially extending ridge 138 or “squealer tip” around the periphery of the tip for tip-to-shroud clearance control This ridge can be fabricated, repaired, or replaced using one or more preforms to form layers 40E, 40F in accordance with aspects of the invention. For example, a damaged squealer tip may be partly or completely milled away and rebuilt with one or more preforms The whole end of a blade can be rebuilt this way if needed

The directed energy 58 described herein may be an energy beam such as an electron beam, one or more circular laser beams, a scanned laser beam (scanned one, two or three dimensionally), an integrated laser beam, etc. A diode laser beam with a rectangular cross section may be particularly advantageous for embodiments having a relatively large area to be processed The broad area beam produced by a diode laser helps to reduce heat density, heat affected zone, dilution from the substrate and residual stresses, all of which reduce the tendency for the cracking effects normally associated with superalloy repair. Optical conditions and optics used to generate a broad area laser exposure may include but are not limited to: defocusing of the laser beam, use of diode lasers that generate rectangular energy sources at focus; use of integrating optics such as segmented mirrors to generate rectangular energy sources at focus; scanning (rastering) of the laser beam in one or more dimensions; and the use of focusing optics of variable beam diameter (e.g. 0.5 mm at the spot for fine detailed work varied to 2.0 mm at the spot for less detailed work).

Advantages of this process over known laser melting or sintering processes include′ allows a wide range of usable metal particle sizes; high deposition rates and thick deposit in each processing layer; improved shielding that extends over the hot deposited metal without the need for inert gas, flux enhanced cleansing of the deposit of constituents that otherwise lead to solidification cracking; flux enhanced laser beam absorption and minimal reflection back to processing equipment, and fabrication/repair on non-horizontal and curved surfaces. Slag formation shapes and supports the deposit, preserves heat and slows the cooling rate, thereby reducing residual stresses that otherwise contribute to strain age (reheat) cracking during post weld heat treatments. The flux may compensate for elemental losses or add alloying elements Metal powder and flux pre-placement in a preform can reduce the time involved in total part building because it allows greater thickness of the deposit

Repair processes for superalloy materials in accordance with embodiments of the present invention may include preparing the superalloy material surface to be repaired by grinding or other material removal process as desired to remove defects, cleaning the surface, and then preparing a preform that matches the prepared surface Some metal and flux powder may be placed in depressions formed by surface grinding prior to placing the preform thereon, which holds such powder in place The energy beam is then traversed across the surface to melt the powder and an upper layer of the substrate into a melt pool having a floating slag layer, then allowing the melt pool and slag to solidify This heals any surface defects at the surface of the substrate, leaving a renewed surface upon removal of the slag by known mechanical and/or chemical processes

The preform may be formed from a first layer of a first metal alloy, a second layer of a second metal alloy, and a third layer of the flux powder, resulting in a mixture or combination of the alloys and/or a gradient of the alloys within a given final layer, depending on the directed energy parameters.

While various embodiments of the present invention have been shown and described herein, it will be obvious that such embodiments are provided by way of example only Numerous variations, changes and substitutions may be made without departing from the invention herein. Accordingly, it is intended that the invention be limited only by the spirit and scope of the appended claims.

The invention claimed is:

1. A process comprising:
forming a preform comprising a metal and a flux, wherein the metal is distributed in the preform responsive to a desired shape of a metal layer of a metal component;
placing the preform on a working surface,
directing an energy beam onto the preform to melt the metal, forming the metal layer overlaid by a slag layer; and
removing the slag layer

2. The process of claim 1, further comprising forming the preform as a container enclosing unbound particles of the metal and flux

3. The process of claim 2, further comprising partitioning the container into a plurality of compartments, wherein at least a first one of the compartments encloses the unbound particles of the metal and flux.

4. The process of claim 3, further comprising loading at least a second one of the compartments with a non-metallic energy beam blocking material

5. The process of claim 3, further comprising including dry ice in at least one of the compartments.

6. The process of claim 1, further comprising:
forming the preform as a container partitioned into a plurality of compartments,
loading a first one of the compartments with first particles comprising the metal having a first average particle diameter, and
loading a second one of the compartments with second particles comprising the metal having a second different average particle diameter.

7. The process of claim 1, further comprising forming the preform as a container with opposed first and second walls enclosing particles of the metal and flux there between, wherein the walls comprise respective peripheries that are sealed to a peripheral frame of a non-metallic energy beam blocking material

8. The process of claim 1, further comprising forming the preform from a series of co-attached tubes, at least one of which contains first particles of the metal and flux.

9. The process of claim 8, wherein at least a second one of the tubes contains a non-metallic energy beam blocking material.

10. The process of claim 1, further comprising forming the preform from a first layer of co-attached tubes containing particles of a first additive manufacturing material, and a second layer of co-attached tubes containing particles of a second additive manufacturing material.

11. The process of claim 10, wherein the first additive manufacturing material comprises a metal-to-ceramic bond coat material, and the second additive manufacturing material comprises a ceramic thermal barrier material

12. The process of claim 10, further comprising conforming the preform to a mandrel before directing the energy beam, wherein the mandrel comprises the working surface shaped to form a curved outer wall of the metal component.

13. The process of claim 1, further comprising placing the preform in a cavity surrounded by separable sections of a split plate before directing the energy beam, wherein the cavity defines a shape of an outer surface of the metal component

14. The process of claim 13, further comprising:
repeating the steps of forming, placing, directing and moving to form a plurality of metal layers, and
using a plurality of split plates with respectively different coefficients of thermal conductivity to control a grain structure of the plurality of layers over a height of the metal component

15. The process of claim 1, further comprising providing a block of an energy-blocking material in the preform before directing the energy, and removing the block after solidification of the layer, thus forming a groove or depression in the layer.

16. The process of claim 1, further comprising providing an interior block of an energy-blocking material in the preform before directing the energy, wherein the interior block comprises a cavity containing a second metal, and removing the block after solidification of the layer, thus forming a groove in the layer with a column of the second metal in the groove.

17. The process of claim 1, further comprising providing the metal in an unbound particulate form, and providing interior blocks of a pre-sintered metal in the preform comprising an open porosity with a void fraction of at least 40%, the blocks arrayed in parallel lines or parallel curves in the preform

18. The process of claim 1, further comprising providing a thermochromatic material in the preform, wherein at least a portion of the metal component comprises the thermochromatic material after fabrication thereof.

19. The process of claim 1, further comprising providing a piezo-electric material in the preform, wherein at least a portion of the metal component comprises the piezo-electric material after fabrication thereof.

20. The process of claim 1, further comprising constituting the metal from particles of different compositions that combine during the melting to create a final superalloy material that constitutes the metal layer.

21. The process of claim 1, further comprising distributing the metal of the preform in a shape of at least a portion of a gas turbine blade squealer tip

22. The process of claim 1, further comprising forming the preform by spark plasma sintering of the metal and flux.

23. The process of claim 22, further comprising forming the metal and flux as two respective distinct layers in the preform

24. The process of claim 22, further comprising forming the preform with a first layer of a first metal alloy, a second layer of a second metal alloy, and a third layer of the flux

25. The process of claim 1, wherein the working surface is a degraded surface of the metal component, and further comprising:
creating a depression in the working surface to remove a damaged portion thereof;
placing the preform in the depression; and
melting the preform with the energy beam to form a repaired surface.

26. The process of claim 25, further comprising:
forming the preform in a predetermined repair shape, and
creating a depression in the working surface responsive to the predetermined repair shape for receipt of the preform.

27. The process of claim 1, further comprising distributing the metal powder in the preform to form the metal layer to be over 3 mm thick.

28. The process of claim 1, further comprising providing the metal in a superalloy composition that is beyond a zone of weldability defined on a graph of superalloys plotting titanium content verses aluminum content, wherein the zone of weldability is upper-bounded by a line intersecting the titanium content axis at 6 wt. % and intersecting the aluminum content axis at 3 wt %

29. The process of claim 1, further comprising forming the preform as a container comprising alumina, silica or aluminum foil

30. A preform for fabricating a layer of a component by additive manufacturing comprising a metal and a flux, wherein the metal is constrained in the preform in a distribution that creates a desired shape of a metal layer of a metal component in response to a melting of the preform with an energy beam.

31. The preform of claim 30, wherein the metal and flux are in unbound particulate form, and the preform further comprises a closed container that constrains the distribution of the metal and flux to create the desired shape,

32. The preform of claim 30, wherein the metal and flux are in constrained in the preform by spark plasma sintering of the metal and flux.
